(19) United States
(12) Patent Application Publication
(10) Pub. No.: US 2003/0154472 A1
(43) Pub. Date: Aug. 14, 2003

(54) Installation server

(75) Inventors: Detlef Daase, Berlin (DE); Bettina Althainz, Berlin (DE); Jens Bohme, Berlin (DE); Irina Muller, Berlin (DE)

Correspondence Address: SUGHRUE MION, PLLC, 2100 Pennsylvania Avenue, NW, Washington, DC, 20037-3213, US

(73) Assignee: ALCATEL

(21) Appl. No.: 10/365,474

(22) Filed: Feb. 13, 2003

(30) Foreign Application Priority Data
Feb. 14, 2002 (DE) 102 06 000.2

(51) Int. Cl. G06F 9/445; G06F 9/44; G06F 15/173; G06F 15/16

(52) U.S. Cl. 717/176; 717/171; 709/223; 709/247

(57) ABSTRACT

The invention relates to a process for installation of a first program code on a server which is connected via a communication network with an installation server and on which a second program code is already installed. The invention further relates to the server and the installation server for performance of this process. A first data set containing the first program code is sent by the installation server via the communication network to the server. A second data set containing a test code for the first program code to be installed is sent by the installation server via the communication network to the server. Before integration of the first program code in the second program code, the server by means of the test code checks the second program code on the server to establish whether it is compatible with the first program code. Only if the result of this check is positive does the server integrate the first program code in the second program code already on the server.

The invention is based on a priority application DE 102 06 000.2 which is hereby incorporated by reference.

### BACKGROUND OF THE INVENTION

The invention concerns a process for installation of a first program code on a server which is connected via a communication network with an installation server and on which a second program code is already installed. In this process a first data set containing the first program code is sent from the installation server to the server via the communication network. The first program code is then integrated in the second program code already on the server. The invention further concerns a server and an installation server for performance of the process.

The invention arises from the process normally used in telecommunications technology for the installation of “patches”.

“Patches” are small software packets which must be installed on a multiplicity of network elements of a telecommunication network to correct errors or improve performance. These “patches” are loaded onto the network elements by the operator of the telecommunication network. They can then be installed in the software of the network elements by means of remote access by the operators.

The disadvantage of this process is that it is very time-consuming and requires a high training level of the network operator.

### SUMMARY OF THE INVENTION

The invention is now based on the object of improving the installation of program code on servers on which program code is already installed.

This object is achieved by a process for installation of a first program code which is connected via a communication network with an installation server and on which is already installed a second program code, where in the process

the installation server sends to servers via the communication network a first data set containing the first program code and

the first program code is integrated in the second program code already on the server,

wherein

the installation server sends to the servers via the communication network a second data set containing a test code for the first program code to be installed,

before integration of the first program code in the second program code, the server by means of the test code checks the program code on the server to establish whether it is compatible with the first program code, and

the server integrates the first program code in the second program code already on the server if the result of the check is positive.

The object is further achieved by a server with an interface unit for communication with an installation server via a communication network and with an installation unit for installation of the first program code on the server where the installation unit is structured so that it receives from the installation server via the communication network a first data set containing the first program code, wherein the installation unit is further designed so that it receives from the installation server via the communication network a second data set containing a test code for the program code to be installed, that before integration of the first program code in the second program code, by means of the test code it checks the second program code on the server to establish whether it is compatible with the first program code, and that if the result of the check is positive, it integrates the first program code in the second program code already on the server.

The object is further achieved by an installation server to support the installation of a first program code on one or more servers, each of which is connected via a communication network with the installation server and on which a second program code is already installed, where the installation server has a memory unit to store the first program code and a control unit designed so that it arranges the sending of a first data set containing the first program code via the communication network to the server or servers for integration of the first program code in the second program code already on the server concerned, wherein the control unit is further designed so that it arranges the sending of a second data set containing a test code for the first program code to be installed, via the communication network to the server or servers, where the test codes are structured so that the respective server can by this means, before integration of the first program code in the second program code, check the second program code on the server concerned to establish whether it is compatible with the first program code.

The invention is based on the concept of transmitting to the server together with the program code to be installed on the server a specific test code for this program code. Before the program code is automatically integrated by the server on the software already on the server, by means of the specific test code the compatibility is checked of the software on the server with the program code. The server then integrates the program code into the software already on the server only if the end result of the test is positive.

This approach firstly brings the advantage that the program code can be distributed for installation to a multiplicity of servers which do not have uniform specific current software installations. The process according to the invention here avoids error occurring in installation of the program code. It is possible to automate largely or completely the actual integration of the program code in the software on the server. It is firstly possible to use network operators with lower training levels and reduce the network operator time necessary for installation. Secondly the availability of the entire system is increased. Errors in software installation are largely prevented by the process according to the invention. Therefore it is particularly suitable for use in areas where there are high security requirements.

A further advantage is that the installation of program code in a multiplicity of servers is made more flexible. The individual software installation of these servers need no longer be essentially uniform. This simplifies administration of the entire system.

Advantageous embodiments of the invention are given in the sub-claims.

It is advantageous to transmit to the server with the program code and test code an installation code for the program code to be installed. The installation code here shows how the program code should be integrated in the software already on the server. This further increases the flexibility of the installation process.

It is further advantageous not to automate fully the installation of the program code on the server but only activate the integrated program code on command of the network operator. Thus the final decision remains with the network operator and the security of the entire system is increased.

Furthermore it is advantageous to transmit the program code to the server in compressed form. This reduces the bandwidth necessary for transfer of the program code.

Furthermore it is advantageous to store the program code on the server before and after integration of the program code transmitted. By means of this back-up strategy it is possible to omit the uninstall routine and reduce the local memory necessary for back-up.

Furthermore it is advantageous, in an installation server controlling the program code installation, to store a distribution list describing the installation condition of the network elements. By means of this distribution list it is possible to make a preselection of servers to which is sent the program code to be installed. This further increases the security and efficiency of the entire system.

It is naturally also possible to use the invention not only for installation of program code on elements of a telecommunication network. The invention rather is generally suitable for the installation of program code on servers on which software is already installed. It is therefore suitable for use in any computer systems.

### BRIEF DESCRIPTION OF THE DRAWINGS

The invention is described in more detail below with reference to several embodiment examples and the enclosed drawings as an example.

FIG. 1 shows a block circuit diagram of the system with an installation server according to the invention and a multiplicity of servers according to the invention.

FIG. 2 shows a functional view of the installation server according to FIG. 1 and a server according to FIG. 1.

### DETAILED DESCRIPTION OF THE DRAWINGS

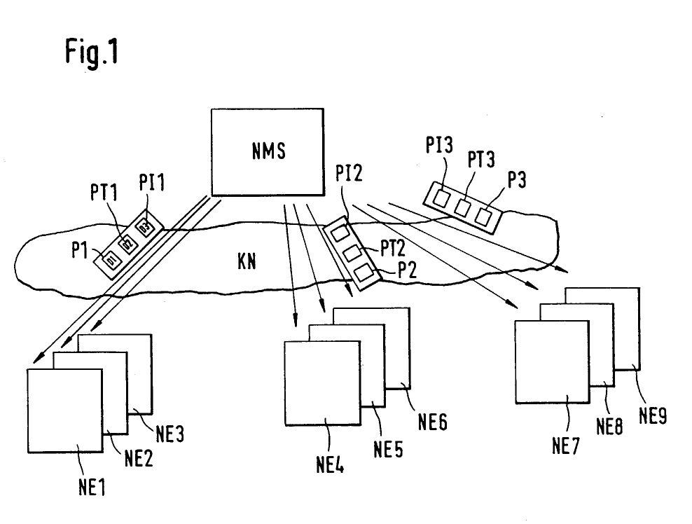

FIG. 1 shows an installation server NMS, a communication network KN and several servers NE1 to NE9.

The communication network KN is a data network. This is for example a LAN (local area network) based on Ethernet protocol. The communication network KN can also be a MAN (metropolitan area network) or ATM (asynchronous transfer mode)-based network. It is also possible that the communication network KN consists of several part networks. Such part networks can be based on different transport protocols or be allocated to different network operators. The connecting layer here can be a TCP/IP protocol stack (TCP=transmission control protocol, IP=Internet protocol). It is further possible that the communication network KN is a signalling network of a telecommunication network.

The installation server NMS controls the installation of program code on servers NE1 to NE9. Server NMS can also be a server of the network management system of a telecommunication network. It is also possible that the installation server NMS is a server within a computer system which is used to manage the computer system.

Servers NE1 to NE9 are servers on which program code is to be installed. The number of servers NE1 to NE9 is selected as an example. On each of servers NE1 to NE9 a program code is already installed. The program code installed can vary here from server to server.

Servers NE1 to NE3, NE4 to NE6 and NE7 to NE9 each form a group of servers which have a similar software installation.

Servers NE1 to NE9 are each connected with the communication network KN. The installation server NMS is also connected with communication network KN. Both the installation server NMS and servers NE1 to NE9 also have means (corresponding interface cards and software drivers) to communicate with each other via the communication network KN. In this sense the installation server NMS and servers NE1 to NE9 are connected together via the communication network KN.

It is also possible that one of the servers NE1 to NE9 or the installation server NMS is connected with the communication network KN via an air interface, for example a radio connection.

Different program codes are already installed on servers NE1 to NE3. To install a program code P1 on servers NE1 to NE3, the installation server NMS sends to the servers NE1 to NE3 via the communication network KN a first data set D1 containing the program code P1. The installation server NMS also sends to the servers NE1 to NE3 via the communication network KN a data set D2 containing a test code PT1 for the program code P1 to be installed.

It is also possible that the installation server NMS sends to servers NE1 to NE3 via the communication network KN a data set 3 containing an installation code PI1 for the program code P1 to be installed. The installation code PI1 is used by servers NE1 to NE3 to integrate program code P1 according to this installation code PI1 in the program code already on the server concerned. Naturally the transmission of data set D3 could also be omitted. Servers NE1 to NE3 could for example contain an independent logic which determines how the program code P1 is to be integrated in the program code already on servers NE1 to NE3.

On receipt of data set D1 and D2 servers NE1 to NE3 perform the following process:

Before integration of program code P1 in the program code already on the respective server, the server NE1 to NE3 by means of test code PT1 checks the program code already on the server to establish whether it is compatible with the first program code. Only if the result of the check is positive, i.e. if the program code already on the server appears compatible with program code P1, does the server concerned integrate program code P1 in the code already on the server.

Similarly, for installation of program code P2, the installation server NMS sends data sets with program code P2, a test code TP2 and an installation code P12 to servers NE4 to NE6. For installation of a program code P3 the installation server NMS sends data sets with the program code P3, a test code PT3 and an installation code P13 to servers NE7 to NE9.

The detailed structure and function of the installation server according to the invention and a server according to the invention are clarified below by means of the function of the installation server NMS and server NE1.

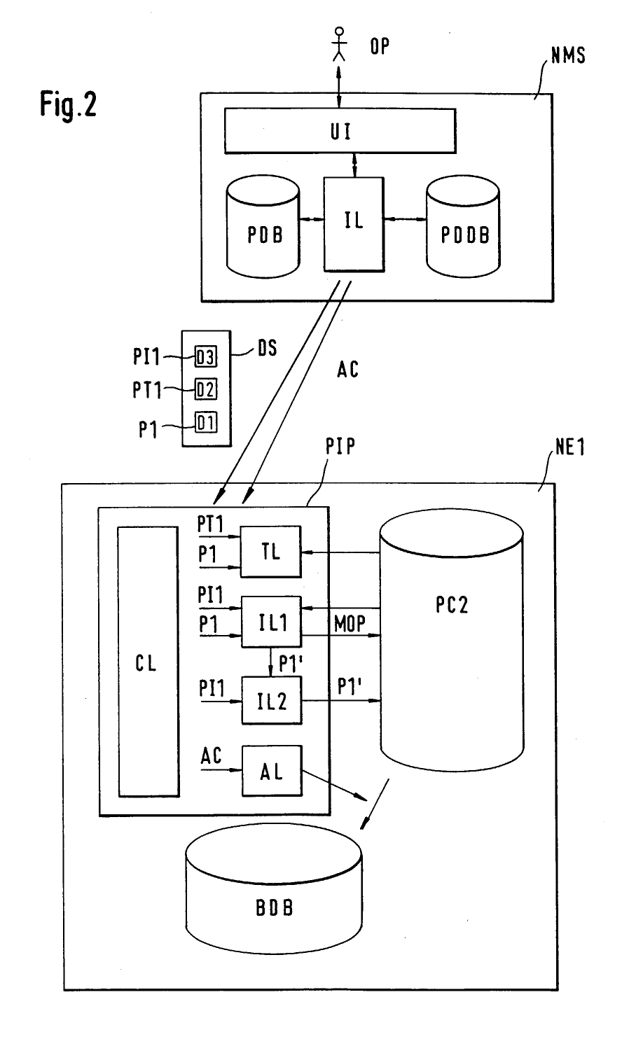

FIG. 2 shows the installation server NMS and server NE1.

The installation server NMS consists of one or more computers connected together, the software platform to be installed on these computers, and application programs to be run on these software platforms. In the execution of these application programs on the system platform of the installation server NMS, the functions described below of installation server NMS are performed.

Functionally the installation server NMS has a user interface UI, a control unit IL and two memory units PDB and PDDB.

User interface UI prepares the communication with a network operator OP or a system administrator. It is advantageous that the user control takes place via a graphical user interface.

Memory unit PDB is a database or data structure provided on the system platform of the installation server NMS. The memory unit PDB contains program codes to be installed and allocated test codes and installation codes. In addition further data can be allocated to each stored program code. This data concerns for example information on the type of server on which the stored program code can be installed, data on the function of the stored program code, data on the date of production and organisation which produced the program code or data on program code authorisation.

Program code in this sense is firstly executable code for example object code or libraries, or code to be interpreted for example Java Applets. Secondly, program code in this context includes configuration files, data describing information to be shown or other data forming input data for computer programs or influencing their function.

Within memory unit PDB is for example stored a list, the lines of which are allocated one to each of program codes P1, P2 and P3, and the columns of which contain the program code, test code, installation code and other data. It is naturally also possible to structure this data differently within memory unit PDB. For example it is possible to organise program codes, allocated test codes, allocated installation code and other allocated data by means of a linked list.

Memory unit PDDB can be structured in the same way as memory unit PDB. Memory unit PDDB has a distribution list describing the installation state of servers NE1 to NE9. The distribution list can firstly comprise a distribution matrix describing which program codes stored in memory unit PDB are already installed on which servers NE1 to NE9. The distribution list can further contain details of the program codes already installed on servers NE1 to NE9. For example the distribution list can contain information on which programs are at present installed on which servers NE1 to NE9. The distribution list can also contain information describing the system properties of servers NE1 to NE9.

Control unit IL controls the installation of program codes on servers NE1 to NE9. The function of the control unit IL is here performed by application programs running on the system platform of installation server NMS.

If the control unit IL receives via user interface UI a command to install program code P1 on servers NE1 to NE3, it arranges the transmission of data set D1 containing program code P1 via the communication network KN to servers NE1 to NE3. Data set D1 is here sent to servers NE1 to NE3 together with a special command. This command tells the servers NE1 to NE3 that data set D1 serves for integration of program code P1 in the program code already on the server NE1 to NE3 concerned. The control unit IL further arranges that the data set D2 containing the test code PT1 for program code P1 to be installed is transmitted via the communication network KN to servers NE1 to NE3.

The test code PT1 transmitted here is designed so that the servers NE1 to NE3 can by this means check the program code already on the servers NE1 to NE3 prior to integration of program code P1 to establish whether it is compatible with program code P1.

During this check the test code PT1 can check the program code already on the server concerned to establish whether certain programs or program versions are present and their configuration complies with the requirements of program code P1. Furthermore it is also possible that test code PT1 contains one or more executable test programs, execution of which generates on the server concerned a result by means of which it can be checked whether the necessary peripheral conditions are present for program code P1. Here it is also possible that test code PT1 contains information for the interpretation of the result of such a test program.

Further it is also possible that test code PT1 contains information on specific preliminary conditions to be fulfilled by a server in order to guarantee the compatibility of program code P1. By means of the test code the server then checks the program code on the server to establish whether the server fulfils such specific preliminary conditions.

Control unit IL further arranges transmission of data set D3 via communication network KN to servers NE1 to NE3. Data set D3 contains the installation code TI1 for program code P1 to be installed. Installation code P11 is here structured so that it supports the relevant servers NE1 to NE3 in the integration of program code P1 in the program code already on the server concerned. Installation code PI1 contains specific instructions on how program code P1 is to be integrated in the program code already on the relevant server. Such instructions can concern the integration of program code P1 in the program code already on the server and concern any necessary adaptation of program code P1 or the program code already on the server.

It is possible that control unit IL arranges transmission of data sets D1, D2 and D3 to servers NE1 to NE3 within a complete packet DS. It is also possible that data sets D1, D2 and D3 are sent together with the relevant control instructions as individual packets to the servers NE1 to NE3.

It is advantageous that the control unit IL compresses program code P1 before transmission and data set D1 thus contains program code P1 in compressed form. Naturally it is also possible that program code P1 is already stored in memory unit PDDB in compressed form. Furthermore it is advantageous that the data sets D1, D2 and D3 present in the packet DS are compressed jointly.

It is possible that control unit IL is not instructed by the network operator OP via user interface UI to send the program code P1 to servers NE1 to NE3. It is also possible that control unit IL by means of access to the data of memory unit PDDB independently selects those servers to which the program code P1 must be sent. For example control unit IL can select the servers of the same type, for which installation of program code P1 is necessary or useful for the function. Thus the network operator need not make the detailed selection of servers on which program code P1 is to be installed. Control unit IL can also make a preselection for the network operator showing to which server which program code present in the memory unit PDB should be sent for installation.

Server NE1 is for example a network element of a telecommunication network. It is particularly advantageous if server NE1 is a billing server of a telecommunication network. With such billing servers there are very high requirements for operating reliability so the use of the invention on such servers is particularly advantageous.

Server NE1 consists of a computer and the software to be placed on this computer. The computer has an interface unit for communication with installation server NMS via communication network KN. Such an interface unit consists for example of a socket or radio component by means of which communication is possible with communication network KN.

When the software is run on the computer the functions described below of server NE1 are performed. Some of this software is a program which supports the installation of program code on the system platform of server NE1. Functionally this program forms an installation unit PIP. Server NE1 further has a program code PC2 already installed on the server and a memory unit BDB.

Program code PC2 can comprise the entire software of server NE1. It is naturally also possible that program code PC2 only comprises running programs or parts of running programs of the server NE1. For example it is possible that program code PC2 does not include the program forming the installation unit PIP and the program of the software platform of server NE1. Program code PC2 can comprise data as well as running programs.

Memory unit PDB serves to secure the data of server NE1. Memory unit BDB is for example a hard disk drive, a tape drive or an optical memory.

Installation unit PIP has several function units CL, TL, IL1, IL2 and AL. Each function unit performs a special function within the program forming the installation unit PIP.

The installation unit PIP receives from installation server NMS via communication network KN the data set D1 containing program code P1. The installation unit PIP also receives from the installation server NMS via communication network KN the data set D2 containing the test code PT1 for the program code P1 to be installed. The function unit TL checks the program code PC2 on server NE1 by means of test code PT1 to establish whether it is compatible with program code P1.

The function unit CL co-ordinates the functions of function units TL, IL1, IL2 and AL. If the installation server NMS receives an instruction with data sets D1 and D2 instructing the installation of the program code contained in data set D1 on server NE1, function unit CL in turn instructs function unit TL by means of program code P1 and test code PT1 to check the compatibility of program code P1 with program code PC2. The result of this check is given to function unit CL by function unit TL. If the result of the check is positive, i.e. there is compatibility, function unit CL instructs the function units IL1 and IL2 to integrate program code P1 in program code PC2. If the result is negative, function unit CL prohibits the integration of program code P1 in program code PC2. In this case it is also advantageous that function unit CL arranges transmission of a corresponding message to the installation server NMS.

The compatibility is checked by function unit TL using the possibilities specified above. Thus for example the conditions specified in test code PT1 are checked when program code PC2 is tested for compliance with these conditions. Furthermore it is possible that a test program specified in test code PT1 is run and the result of this test program is compared with analysis information present in test code PT1. It is also possible that program code P1 or parts of program code P1 are run in a monitored state and the result analysed by means of a test pattern contained in the test code.

Function units IL1 and IL2 control the integration of program code P1 in program code PC2. Function units IL1 and IL2 integrate program code P1 according to installation code PI1 in the program code PC2 already on the server NE1. It is also possible that the function units IL1 and IL2 perform this integration on the basis of an independent logic without the aid of installation code PI1. This however has the disadvantage that installation of program code P1 cannot be adapted to the specific requirements of program code PC2.

Function unit IL1 adapts program code P1 to program code PC2 according to the installation code PI1. On the basis of information on program code PC2 and the instructions of installation code PI1, function unit IL1 then changes the program code P1 into program code P1′. Further it is also possible that function unit IL1 changes program code PC2 according to installation code P11 for adaptation to program code P1. On the basis of information on program code PC2 and the instructions from installation code PI1, function unit IL1 thus performs modifications MOD in program code PC2.

Function unit IL2 inserts modified program code P1′ in program code P2 according to installation code PI1. Here it is also possible that for insertion by function unit IL2 further information on program code P2 is determined. This information is then analysed according to the instructions of installation code PI1.

In the integration by function units IL1 and IL2 of program code P1′ in program code PC2 already on the server, part of the program code PC2 is replaced by program code P1. It is also possible that in this integration, program code P1′ is added to program PC2.

Function unit AL activates the integration of program code P1 in program code PC2 by function units IL1 and IL2. For example the changes made by function units IL1 and IL2 only become active on a new system start. The function unit AL in this case arranges activation of the integration by arranging a restart of the system. Function unit AL activates integration of the integrated program code only on a command from the installation server NMS. So function unit AL activates integration for example only when server NE1 receives a command AC from installation server NMS.

Function unit AL also controls the storage of program codes PC2 in memory unit PDB. It arranges storage of program code PC2 before integration of program code P1 and after integration of program code P1. It is also possible that function unit AL arranges storage of program code PC2 before activating the integration of program code P1 into program code PC2 and after activating this integration.

1. Process for installation of a first program code on a server which is connected via a communication network with an installation server and on which is already installed a second program code, where in the process
the installation server sends to servers via the communication network a first data set containing the first program code and
the first program code is integrated in the second program code already on the server,
wherein
the installation server sends to the servers via the communication network a second data set containing a test code for the first program code to be installed,
before integration of the first program code in the second program code, the server by means of the test code checks the program code on the server to establish whether it is compatible with the first program code, and
the server integrates the first program code in the second program code already on the server if the result of the check is positive.

2. Process according to claim 1, wherein
the installation server sends to the server via the communication network a third data set containing the installation code for the first program code to be installed, and
the server integrates the first program code in the program code already on the server in accordance with this installation code.

3. Process according to claim 1, wherein the server adapts the first program code to the second program code in accordance with the installation code.

4. Process according to claim 1, wherein the server inserts the first program code in the second program code in accordance with the installation code.

5. Process according to claim 1, wherein the server modifies the second program code according to the installation code for adaptation to the first program code.

6. Process according to claim 1, wherein the integration of the first program code in the second program code already on the server, the server replaces part of the second program code with the first program code.

7. Process according to claim 1, wherein the server activates the integrated first program code on a command by the installation server.

8. Process according to claim 1, whereby before the integration of the first program code in the second program code, by means of the test code the server checks the second program code on the server to establish whether the server fulfils one or more specific preconditions.

9. Process according to claim 1, wherein the first data set contains the first program code in compressed form.

10. Server with an interface unit for communication with an installation server via a communication network and with an installation unit for installation of the first program code on the server where the installation unit is structured so that it receives from the installation server via the communication network a first data set containing the first program code, wherein the installation unit is further designed so that it receives from the installation server via the communication network a second data set containing a test code for the program code to be installed, that before integration of the first program code in the second program code, by means of the test code it checks the second program code on the server to establish whether it is compatible with the first program code, and that if the result of the check is positive, it integrates the first program code in the second program code already on the server.

11. Server according to claim 10, wherein the installation unit is further designed so that it arranges storage of the second program code before and after integration of the first program code in the second program code.

12. Installation server to support the installation of a first program code on one or more servers, each of which is connected via a communication network with the installation server and on which a second program code is already installed, where the installation server has a memory unit to store the first program code and a control unit designed so that it arranges the sending of a first data set containing the first program code via the communication network to the server or servers for integration of the first program code in the second program code already on the server concerned, wherein the control unit is further designed so that it arranges the sending of a second data set containing a test code for the first program code to be installed, via the communication network to the server or servers, where the test codes are structured so that the respective server can by this means, before integration of the first program code in the second program code, check the second program code on the server concerned to establish whether it is compatible with the first program code.

13. Installation server according to claim 12, wherein the control unit is further designed so that it arranges the sending of the first data set and the second data set to a multiplicity of servers of the same type.

14. Installation server according to claim 12, wherein the test code is further designed so that different servers with different second program codes can by means of the test code check the respective second program code, before integration of the first program code in the second program code concerned, to establish whether it is compatible with the first program code.

15. Installation server according to claim 12, wherein control unit is further structured so that it arranges the sending of the first data set and the second data set to a multiplicity of network elements of a telecommunication network.

16. Installation server according to claim 12, wherein the control unit is further structured so that it is fitted with a second memory unit to store a distribution list describing the installation status of the servers.
